(19) United States
(12) Patent Application Publication
(10) Pub. No.: US 2022/0315465 A1
(43) Pub. Date: Oct. 6, 2022

(54) PACKED ROTATING BIOLOGICAL CONTACTOR AND METHOD FOR AMMONIA NITROGEN CONVERSION BASED ON THE PACKED ROTATING BIOLOGICAL CONTACTOR

(71) Applicant: Guilin University of Technology, Guangxi Province (CN)

(72) Inventors: Honghu Zeng, Guangxi Province (CN); Minhao Zheng, Guangxi Province (CN); Xinghui Feng, Guangxi Province (CN); Zongqiang Zhu, Guangxi Province (CN); Yanpeng Liang, Guangxi Province (CN)

(21) Appl. No.: 17/372,916

(22) Filed: Jul. 12, 2021

(30) Foreign Application Priority Data
Apr. 1, 2021 (CN) 202110356981.3

(51) Int. Cl. C02F 3/08; C02F 3/00

(52) U.S. Cl. CPC C02F 3/082; C02F 3/006; C02F 2209/005

(57) ABSTRACT

The present disclosure provides a packed rotating biological contactor and a method for ammonia nitrogen conversion based on the packed rotating biological contactor. The packing frame of the packed rotating biological contactor provided in the present disclosure is formed by engaging two meshed disks, the hollow structure thus formed can be filled with packings, increasing the tilling amount of the packings; the selection of packing types can improve the film-forming rate of microorganism and shows a good adsoiption effect on the microorganism, so that the biofilm formed on the surface of packings can resist the impact of water flow and avoid shedding. The selection of disk meshes and packing types also increases the specific surthce area of the packed rotating biological contactor, which can improve the acclimation efficiency of microorganisms and enable the packed rotating biological contactor to carry more microorganisms, thus forming biofilms with excellent performance.

### CROSS REFERENCE TO RELATED APPLICATIONS)

This patent application claims the benefit and priority of Chinese Patent Application No. 202110356981.3, filed on Apr. 2, 2021, the disclosure of which is incorporated by reference herein in its entirety as part of the present application.

### FIELD OF THE INVENTION

The present disclosure relates to the technical field of nitrogen recycling, and specifically relates to a packed rotating biological contactor and a method for ammonia nitrogen conversion based on the packed rotating biological contactor.

### BACKGROUND OF THE INVENTION

Nitrogen is a major component of protein in crop cells and also of organic compounds such as chlorophyll and plant hormones, so the appropriate addition of nitrogen fertilizers is beneficial to improve the yield and quality of crops. Commonly used nitrogen fertilizers include ammonium nitrogen fertilizers (mainly including (NH₄)₂SO₄, NH₄Cl, etc.), nitrate nitrogen fertilizers (mainly including NaNO₃, Ca(NO₃)₂, etc.), amide nitrogen fertilizers (mainly including CO(NH₂)₂, also known as urea). Ammonium nitrogen fertilizers are easily adsorbed by soil colloid, so after a. long time of enrichment, it is prone to form an environment with a locally high concentration of ammonium nitrogen, which will produce toxic effects on the growth of crops; in addition, excessive absorption of ammonium nitrogen by crops will inhibit the absorption of nutrients such as calcium, magnesium, and potassium, to some extent. Nitrate nitrogen fertilizers are soluble in water, can be absorbed by crops more easily, and have no inhibition on the absorption of nutrients such as calcium, magnesium, and potassium; nitrates are negatively charged and cannot be absorbed by crops easily, thus avoiding locally high nitrogen environment; but nitrate nitrogen fertilizers are relatively expensive, so there are few large-scale applications. Urea is a kind of nitrogen fertilizer with the highest nitrogen content in solid nitrogen and has a relatively low price, so it is used most widely; urea mainly exists in soil and water environment as ammonium nitrogen after hydrolysis in soil. In actual agricultural production, a large amount of urea application results in excess nitrogen in agricultural areas and water bodies, which is an important factor not to be ignored causing eutrophication of agricultural water bodies. It is found by field investigation of rice growing areas that, ammonia nitrogen in agricultural ditches changes seasonally, the concentration of which ranges from about 20-150 mg/L.

At present, there have been no effective measures for rational treatment of nitrogen in agricultural ditches, discharging into large-scale water bodies for dilution is still the commonly used method, which is also the major factor causing water eutrophication in an agricultural wetland. Ammonia nitrogen in water or soil is easily converted to nitrite nitrogen by ammonia oxidizing bacteria (AOB) under aerobic and alkaline conditions, and then converted to nitrate nitrogen by nitrite oxidizing bacteria (NOB). For this, by using the packed rotating biological contactor, the ammonia. nitrogen in agricultural ditches can be enriched and converted firstly, and then recycled for irrigation in forms of nitrate nitrogen; its principle is mainly as follows: after biological acclimation, the biofilms formed on the packings in the rotating biological contactor are enriched in AOB and NOB, so that the rotating biological contactor is capable of both absorbing ammonia nitrogen and converting ammonia nitrogen, and it can be applied in agricultural ditches by optimizing the oxygen supply and reasonable addition of alkalinity.

However, the existing packed. rotating biological contactors have the disadvantages of a small specific surface area, poor film-forming performance, low treatment efficiency, and a short lifespan. Therefore, it is necessary to provide a packed rotating biological contactor with a large specific surface area, good film-forming performance, and high treatment efficiency.

### SUMMARY OF THE INVENTION

In view of this, the present disclosure is intended to provide a packed rotating biological contactor and a method for ammonia nitrogen conversion based on the packed rotating biological contactor. The packed rotating biological contactor provided in the present disclosure has the advantages of large specific surface area, good film-forming performance, high treatment efficiency, and a long lifespan.

To achieve the above inventive purposes, the present disclosure provides the following technical solutions:

The present disclosure provides a packed rotating biological contactor, including a rotating shaft, several pumping plates and several packing frames; each of the packing frames is formed by engaging two meshed disks; the packing frames have hollow structures; the hollow structures of the packing frames are filled with packings, and the packings include natural zeolite and/or medicinal stone;

the rotating shaft passes through the center of the packing frames, and drives the packing frames to rotate around the rotating shaft.

Preferably, the mesh diameter of the disks is 0.85-2 mm; the mesh density of the disks is set at 10-20 meshes; the particle size of the packings is 3-18 mm; and the packing density of the packings is 60-80%.

Preferably, the packing frames are made of wood, bamboo, PMMA, or PVC.

The present disclosure also provides a method for ammonia nitrogen conversion based on the packed rotating biological contactor, including the following steps:

(1) placing the packed rotating biological contactor into a reactor, simulating continuous inflow of water, the packings of the packed rotating biological contactor adsorbing the inflow water; when the ammonia nitrogen concentration in outflow water is reduced to 20-30% of the ammonia nitrogen concentration in the simulated inflow water, continuing the water inflow; when the ammonia nitrogen concentration in the outflow water is raised to 90-100% of the ammonia nitrogen concentration in the simulated inflow water, stopping the water inflow and the water outflow; inoculating the water within the reactor with activated sludge, and regulating alkalinity and aerating; the microorganism in the activated sludge is converted, when the nitrate nitrogen concentration in the water within the reactor is raised to 70-90% of the ammonia nitrogen concentration in the simulated inflow water, the conversion is completed; then draining the reactor;

(2) repeating (1) until the hydraulic retention time during the adsorption process is 10±2 h, to get a rotating biological contactor having the ability of ammonia nitrogen conversion;

(3) placing the rotating biological contactor having the ability of ammonia nitrogen conversion into a treatment reactor, and continuously inflowing the water to be treated for ammonia nitrogen conversion;

the packed rotating biological contactor is the packed rotating biological contactor as described in the above technical solution;

the reagent for regulating alkalinity is NaHCO₃ or Na₂CO₃, and the mass ratio of the reagent for regulating alkalinity to the ammonia nitrogen in the water within the reactor is (7-9):1.

Preferably, in step (1), 50% of the area of the packed rotating biological contactor is immersed under the liquid level; and the total volume of the packings in the packed rotating biological contactor is 25-50% of the volume of the reactor;

the ammonia nitrogen concentration of the simulated inflow water is 50 mg/L, and its pH value is 7.0±0.5;

the adsorption includes the following parameters: the rotating speed of the packed rotating biological contactor is 0.6-15 r/min, the water temperature is 30±5° C., and the hydraulic retention time is 8-16 h.

Preferably, in step (1), the MISS of the activated sludge is 2500-3000 mg/L; and the ratio of the adding mass of the activated sludge to the volume of the reactor is (10-15) g:1 L;

the aeration maintains the dissolved oxygen concentration of the water within the reactor at 3-5 mg/L.

Preferably, in step (3), the ammonia nitrogen concentration of the water to be treated is 20-150 mg/L.

Preferably, in step (3), the parameters for ammonia nitrogen conversion include: 50% of the area of the packed rotating biological contactor is immersed under the liquid level; the rotating speed of the packed rotating biological contactor is 0.6-8 r/min, and the water temperature is 30±5° C.,

Preferably, in step (3), during the process of ammonia nitrogen conversion, when the ammonia nitrogen concentration in the outflow water is below 10 mg/L, it is in normal operation; when the ammonia nitrogen concentration in the water within the treatment reactor is increased to 20±5 mg/L, it is the operational control point; when the operational control point is achieved, post-treatment is conducted, which includes the following steps: stopping the water inflow, supplementing the alkalinity and aerating for ammonia nitrogen desorption-conversion, until the ammonia nitrogen concentration in the within the treatment reactor is reduced to below 10 mg/L, draining the treatment reactor and then continuously inflowing the water to be treated for ammonia nitrogen conversion.

Preferably, in step (3), when the packings in the packed rotating biological contactor harden or the biofilm is too thick, the method further includes rinsing the packings.

The present disclosure provides a packed rotating biological contactor, including a rotating shaft, several pumping plates and several packing frames; each of the packing frames is formed by engaging two meshed disks; the packing flames have hollow structures; the hollow structures of the packing frames are filled with packings, the packings include natural zeolite and/or medicinal stone; the rotating shaft passes through the center of the packing frames, and drives the packing frames to rotate around the rotating shaft. The packing frame of the packed rotating biological contactor provided in the present disclosure is formed by engaging two meshed disks, the hollow structure thus formed can he filled with packings, increasing the filling amount of the packings; the selection of packing types can improve the film-forming rate of microorganism and shows a good adsorption effect on the microorganism, so that the biofilm formed on the surface of packings can resist the impact of water flow and avoid shedding. The selection of disk meshes and packing types also increases the specific surface area of the packed rotating biological contactor, which can improve the acclimation efficiency of microorganisms and enable the packed rotating biological contactor to carry more microorganisms, thus forming biofilms with excellent performance, and further improving the treatment efficiency of the packed rotating biological contactor. In addition, because the packing frame is formed by engaging two meshed disks, so it is detachable so as to rinse the packings, thus enhancing the lifespan of the packed rotating biological contactor. The packings in the packed rotating biological contactor have wide sources and can be obtained easily, and there is no hazard of secondary pollution when being used in agricultural ditches.

The present disclosure also provides a method for ammonia nitrogen conversion based on the packed rotating biological contactor. The present disclosure forms microbial films having the ability of ammonia nitrogen conversion on the surface of packings in the packed rotating biological contactor through microbial acclimation of the packed rotating biological contactor first; the utilization of the novel packed rotating biological contactor improves the film-forming rate of microorganism, thereby obtaining a packed. rotating biological contactor having the ability of ammonia nitrogen conversion with good microbial conversion effect. Treatment of the water to be treated with the rotating biological contactor is simple, and the treatment efficiency of ammonia nitrogen in the water to be treated is improved.

As demonstrated from the data in embodiments, the packed rotating biological contactor of the present disclosure is suitable for water bodies in agricultural ditches with an ammonia nitrogen concentration of 20-150 mg/L, in which the ammonia nitrogen concentration in the outflow water can be effectively controlled below 10 mg/L, and the rate of conversion into nitrate nitrogen can be stabilized at 50-93%.

### BRIEF DESCRIPTION OF THE DRAWINGS

FIG. 1 is the main view of the packing frame as provided in the present disclosure;

FIG. 2 is the sectional view of the packing frame as provided in the present disclosure;

FIG. 3 is a diagram showing the equipment used in the method fir ammonia nitrogen conversion based on the packed rotating biological contactor as provided in the present disclosure;

Where, 1 represents a meshed disk, 2 represents the packings.

### DETAILED DESCRIPTION OF THE INVENTION

The present disclosure provides a packed rotating biological contactor, including a rotating shaft, several pumping plates and several packing frames; each of the packing frames is formed by engaging two meshed disks; the packing frames have hollow structures; the hollow structures of the packing frames are filled with packings, the packings include natural zeolite and/or medicinal stone;

The rotating shaft passes through the center of the packing frames, and drives the packing frames to rotate around the rotating shaft.

The packed rotating biological contactor of the present disclosure includes a rotating shaft. The present disclosure does not concretely definite the material or size of the rotating shaft, as long as employing parameters of the rotating shaft that are well known to those skilled in the art.

The packed rotating biological contactor of the present disclosure includes several pumping plates. The present disclosure does not concretely definite the located position, size, material and number of the pumping plates, as long as employing the material, size, located position and number of the pumping plates commonly used in the packed rotating biological contactor that are well known to those skilled in the art.

The packed rotating biological contactor of the present disclosure includes several packing frames, each of the packing frames is formed by engaging two meshed disks; the packing frames have hollow structures; the hollow structures of the packing frames arc filled with packings; the packings include natural zeolite and/or medicinal stone, further preferably natural zeolite, and the natural zeolite is preferably natural clinoptilolite. In the present disclosure, the particle size of the packings is preferably 3-18 mm; the packing density of the packings is preferably 60-80%. In the present disclosure, the mesh diameter of the disks is preferably 0.85-2 mm; the mesh density of the disks is preferably set at 10-20 meshes. In the present disclosure, the packing frames are preferably made of wood, bamboo, PMMA, or PVC, further preferably PVC.

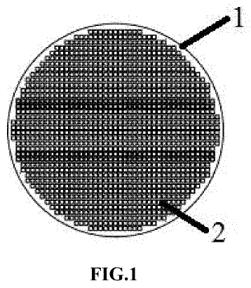

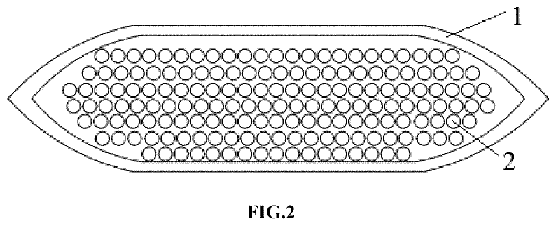

In the present disclosure, FIG. 1 is the main view of the packing frame as provided in the present disclosure; FIG. 2 is the sectional view of the packing frame as provided in the present disclosure; where, 1 represents a meshed disk, 2 represents the packings.

In the present disclosure, the rotating shaft passes through the center of the packing frames, and drives the packing frames to rotate around the rotating shaft.

The present disclosure also provides a method for ammonia nitrogen conversion based on the packed rotating biological contactor, including the following steps:

(1) placing the packed rotating biological contactor into a reactor, simulating continuous inflow of water, the packings of the packed rotating biological contactor adsorbing the inflow water; when the ammonia nitrogen concentration in outflow water is reduced to 20-30% of the ammonia nitrogen concentration in the simulated inflow water, continuing the water inflow; when the ammonia nitrogen concentration in the outflow water is raised to 90-100% of the ammonia nitrogen concentration in the simulated inflow water, stopping the water inflow and the water outflow; inoculating the water within the reactor with activated sludge, and regulating alkalinity and aerating; the microorganism in the activated sludge is converted, when the nitrate nitrogen concentration in the water within the reactor is raised to 70-90% of the ammonia nitrogen concentration in the simulated inflow water, the conversion is completed; then draining the reactor;

(2) repeating (1) until the hydraulic retention time during the adsorption process is 10±2 h, to get a rotating biological contactor having the ability of ammonia nitrogen conversion;

(3) placing the rotating biological contactor having the ability of ammonia nitrogen conversion into a treatment reactor, and continuously inflowing the water to be treated for ammonia nitrogen conversion;

the packed rotating biological contactor is the packed rotating biological contactor as described in the above technical solution.

In the present disclosure, the packed rotating biological contactor is placed into a reactor, the water inflow is simulated continuously, the packings of the packed rotating biological contactor absorb the inflow water; when the ammonia nitrogen concentration in outflow water is reduced to 20-30% of the ammonia nitrogen concentration in the simulated inflow water, the water inflow is continued; when the ammonia nitrogen concentration in the outflow water is raised to 90-100% of the ammonia nitrogen concentration in the simulated inflow water, both the water inflow and the water outflow are stopped; the water within the reactor is inoculated with activated sludge, the alkalinity is adjusted and aeration is performed; the microorganism in the activated sludge is transformed, when the nitrate nitrogen concentration in the water within the reactor is raised to 70-90% of the ammonia nitrogen concentration in the simulated inflow water, the transthrmation is considered as completion; then the reactor is drained; then adsorption and conversion are repeated in turn until the hydraulic retention time during the adsorption process is 10±2 h, to get a rotating biological contactor having the ability of ammonia nitrogen conversion.

In the present disclosure, 50% of the area of the packed rotating biological contactor is immersed under the liquid level; and the total volume of the packings in the packed rotating biological contactor is preferably 25-50% of the volume of the reactor, further preferably 30-15%. In the present disclosure, the ammonia nitrogen concentration in the simulated inflow water is preferably 50 mg/L, and the pH value is preferably 7.0±0.5; the simulated inflow water is preferably an aqueous solution of ammonium chloride,

In the present disclosure, the absorption preferably includes the following parameters: the rotating speed of packed rotating biological contactor is preferably 0.6-15 r/min, further preferably 8 r/min; the water temperature is preferably 30±5° C., and the hydraulic retention time is preferably 8-16 h.

In the present disclosure, when the ammonia nitrogen concentration in the outflow water is reduced to 20-30% of the ammonia nitrogen concentration in the simulated inflow water, the water inflow is continued, so as to increase the ammonia nitrogen concentration in the water within the reactor, thus avoiding the subsequent adsorption of ammonia nitrogen onto the packed rotating biological contactor for microorganism conversion.

In the present disclosure, the MLSS of the activated sludge is preferably 2500-3000 mg/L; the activated sludge preferably comes from landfills or sewage treatment plants, and is preferably pre-treated before use; the pre-treatment includes: rinsing with running water and then filtering the residues, supplementing a certain concentration of ammonia nitrogen and then continuously aerating; the ratio of the adding mass of the activated sludge to the volume of the reactor is preferably (10-15) g:1 L.

In the present disclosure, the reagent for regulating alkalinity is preferably NaHCO₃ or Na₂CO₃, and the mass ratio of the reagent for regulating alkalinity to the ammonia nitrogen in the water within the reactor is preferably (7-9):1, further preferably 7.5:1.

In the present disclosure, aeration is controlled based on the dissolved. oxygen, and the aeration maintains the dissolved oxygen concentration of the water within the reactor preferably at 3-5 mg/L.

After obtaining the rotating biological contactor having the ability of ammonia nitrogen conversion, the present disclosure places it into a treatment reactor, into which the water to be treated inflows continuously to achieve the ammonia nitrogen conversion.

In the present disclosure, the ammonia nitrogen concentration in the water to be treated is preferably 20-150 mg/L.

In the present disclosure, the parameters for ammonia nitrogen conversion preferably include: 50% of the area of the packed rotating biological contactor is immersed under the liquid level; the rotating speed of the packed rotating biological contactor is preferably 0.6-8 r/min, and the water temperature is preferably 30±5° C.

In the present disclosure, during the process of ammonia nitrogen conversion, when the ammonia nitrogen concentration in the outflow water is below 10 mai, it is in normal operation; when the ammonia nitrogen concentration in the water within the treatment reactor is increased to 20±5 mg/L, it is the operational control point; when the operational control point is achieved, post-treatment is conducted, which includes the following steps: stopping the water inflow, supplementing the alkalinity and aerating for ammonia nitrogen desorption-conversion, until the ammonia nitrogen concentration in the water within the treatment reactor is reduced to below 10 mg/L, draining the treatment reactor and then continuously inflowing the water to be treated for ammonia nitrogen conversion.

In the present disclosure, the parameters for supplementing the alkalinity and aerating are preferably consistent with those in the above technical solution, which would not be reiterated here.

In the present disclosure, the desorption-conversion includes two processes: first, desorption of ammonia nitrogen from the packings, also a process of recovering the adsorption capacity of ammonia nitrogen; second, the desorbed ammonia nitrogen is converted into nitrate nitrogen by consuming alkalinity and oxygen under the action of AOB and NOB.

In the present disclosure, during the process of ammonia nitrogen conversion, when the packings in the packed rotating biological contactor harden or the biofilm is too thick, the method further includes rinsing the packings.

In the present disclosure, the reagent used for rinsing is preferably water, and the present disclosure does not concretely definite the parameters for rinsing, as long as rinsing the packings thoroughly,

In the present disclosure, the rinsing solution obtained from rinsing contains a large amount of microbial flora, which can be used for irrigation directly; the replaced packings with reduced adsorption capacities can be buried to the roots of the crops as the nitrogen fertilizer slow-release materials.

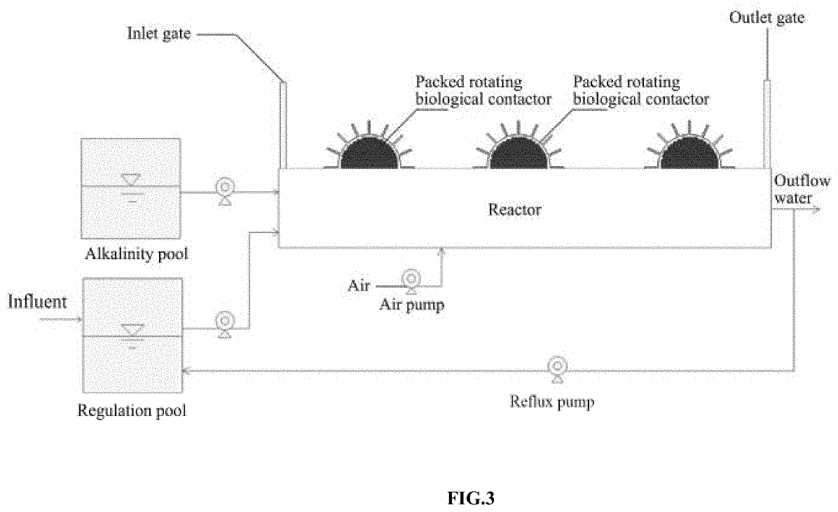

FIG. 3 is a diagram showing the equipment used in the method for ammonia nitrogen conversion based on the packed rotating biological contactor as provided in the present disclosure, including a reactor, the packed rotating biological contactor is placed in the reactor; the opposite two sides of the reactor are respectively provided with an inlet gate and an outlet gate; an air pump is located at the bottom of the reactor, a regulation pool and an alkalinity pool are further connected at the side of the reactor provided with the inlet gate; the regulation pool is provided with grids to remove suspended matters; the alkalinity pool is used for regulating the alkalinity in the reactor, and the air pump is used for aeration.

The packed. rotating biological contactor and the method for ammonia nitrogen conversion based on the packed rotating biological contactor as provided in the present disclosure will be illustrated in detail in combination with the following embodiments, but they should not be construed as the limitation on the protection scope of the present disclosure,

### Embodiment 1

The packed rotating biological contactor includes a rotating shaft, pumping plates and packing frames; each of the packing frames is formed by engaging two meshed disks; the packing frames have hollow structures; the rotating shaft passes through the center of the packing frames, and drives the packing frames to rotate around the rotating shaft,

The hollow structures of the packing frames are filled with packings; the packings are natural zeolite, and the particle size of the natural clinoptilolite is mm; the mesh diameter of the disks is 0.85 mm; the mesh density is set at 20 meshes; and the packing density of the packings is 80%.

1. Natural clinoptilolite was added into the packed rotating biological contactor, the total volume of packings accounted for 30% the volume of the reaction pool; the packed rotating biological contactor was cultivated by means of continuous water inflow, the ammonia nitrogen concentration of the simulated inflow water was 50 mg/L, HRT was 8 h, the water temperature was controlled at 30° C., and the rotating speed of the packed rotating biological contactor was maintained at 4 r/min; the concentrations of ammonia nitrogen, nitrite nitrogen and nitrate nitrogen in the outflow water were detected periodically so as to control the adsorption-desorption processes of ammonia nitrogen.

2. According to the experimental results, during the adsorption stage, the ammonia nitrogen concentration in the outflow water decreased gradually; when the adsorption approached saturation, the ammonia nitrogen concentration increased gradually; when the ammonia nitrogen concentration in the outflow water increased to 45 mg/L, the inlet gate and the outlet gate were shut off, and the water within the reactor was inoculated with activated sludge (MLSS of the sludge was 3000 mg/L, and the ratio of the adding quantity of the sludge to the volume of the reactor was 10 g/L); an alkalinity adding device was used to supplement the alkalinity, in which NaHCO₃ was added at a mass ratio of sodium bicarbonate to the ammonia nitrogen in the water within the reactor of 7.5:1; the aerating device was activated to maintain the dissolved oxygen concentration in the water within the reactor at 5±0.5 mg/L, the rotating speed of the packed rotating biological contactor was maintained at 5 r/min, at which time the nitration reaction was ongoing. At this moment, the ammonia nitrogen concentration in the water within the reaction pool decreased gradually, and the nitrate nitrogen concentration increased slowly; when the nitrate nitrogen concentration in the water within the reaction pool increased to 40 mg/L, the nitration reaction was finished; microorganisms gradually formed biofilms on the surface of the packings, NOB gradually dominated in the biofilms, and the acclimation of the packed rotating biological contactor was completed.

3. Four packed rotating biological contactors that have been acclimated were divided into two groups (two in each group) and connected in series to two rotating shafts, which are driven by an electric motor and the rotating speed was maintained at 4 r/min; the ammonia nitrogen concentration of the inflow water to he treated was 50 mg/L, HRT and the water temperature were the same as those in step 1; after treatment through the packed rotating biological contactor, more than about 80% of ammonia nitrogen was converted into nitrate nitrogen, and the concentration of remaining ammonia nitrogen was below about 10 mg/L; the water in the reaction pool was pumped by a centrifugal pump for irrigation; so far, one cycle has been finished, then the water inflow was continued and the above operations were repeated.

It was demonstrated from the experiment that, when the ammonia nitrogen concentration of the water to be treated was 50 mg/L, treatment through the packed rotating biological contactor can realize the entrapment and conversion of ammonia nitrogen, as well as recycling for irrigation.

### Embodiment 2

The packed. rotating biological contactor includes a rotating shaft, pumping plates and packing frames; each of the packing frames is formed by engaging two meshed disks; the packing frames have hollow structures; the rotating shaft passes through the center of the packing frames, and drives the packing frames to rotate around the rotating shaft.

The hollow structures of the packing frames are filled with packings; the packings are natural clinoptilolite, and the particle size of the natural clinoptilolite is 4 mm; the mesh diameter of the disks is 0.85 mm; the mesh density of the disks is set at 20 meshes; and the packing density of the packings is 80%,

1. Natural clinoptilolite was added into the packed rotating biological contactor, the total volume of packings accounted for 30% the volume of the reaction pool; the packed rotating biological contactor was cultivated by means of continuous water inflow, the ammonia nitrogen concentration of the simulated inflow water was 50 mg/L, HRT was 8 h, the water temperature was controlled at 30° C., and the rotating speed of the packed rotating biological contactor was maintained at 4 r/min; the concentrations of ammonia nitrogen, nitrite nitrogen and nitrate nitrogen in the outflow water were detected periodically so as to control the adsorption-desorption processes of ammonia nitrogen.

2. According to the experimental results, during the adsorption stage, the ammonia nitrogen concentration in the outflow water decreased gradually; when the adsorption approached saturation, the ammonia nitrogen concentration increased gradually; when the ammonia nitrogen concentration in the outflow water increased to 45 mg/L, the inlet gate and the outlet gate were shut off, and the water in the reaction pool was inoculated with activated sludge (MLSS of the sludge was 3000 mg/L, and the ratio of the adding quantity of the sludge to the volume of the reaction pool was 10 g/L); an alkalinity adding device was used to supplement the alkalinity, in which NaHCO₃ was added at a mass ratio of sodium bicarbonate to the ammonia nitrogen in the water within the reaction pool of 75:1; the aerating device was activated to maintain the dissolved oxygen concentration in the water within the reaction pool at 5±0.5 mg/k, the rotating speed of the packed rotating biological contactor was maintained at 5 r/min, at which time the nitration reaction was ongoing. At this moment, the ammonia nitrogen concentration in the reaction pool decreased. gradually, and the nitrate nitrogen concentration increased slowly; when the nitrate nitrogen concentration in the water within the reaction pool increased to 40 mg/k, the nitration reaction was finished; microorganisms gradually formed biofilms on the surface of the packings, NOB gradually dominated in the biofilms, and the acclimation of the packed rotating biological contactor was completed.

3. Six packed rotating biological contactors that have been acclimated were divided into two groups (three in each group) and connected in series to two rotating shafts, which are driven by an electric motor and the rotating speed was maintained at 4 r/min; the ammonia nitrogen concentration of the inflow water to be treated was 90 mg/L, HRT was 8 h, and the water temperature was controlled at 30° C.; after treatment through the packed rotating biological contactor, more than 80% of ammonia nitrogen was converted into nitrate nitrogen, and the concentration of remaining ammonia nitrogen was 10-15 mg/L; the water in the reaction pool was pumped by a centrifugal pump for irrigation; so far, one cycle has been finished, then the water inflow was continued and the above operations were repeated.

It was demonstrated from the experiment that, when the ammonia nitrogen concentration of the water to be treated was 90 mg/L, treatment through the packed rotating biological contactor can realize the entrapment and conversion of ammonia nitrogen, as well as recycling for irrigation.

### Embodiment 3

The packed rotating biological contactor includes a rotating shaft, pumping plates and packing frames; each of the packing frames is formed by engaging two meshed disks; the packing frames have hollow structures; the rotating shaft passes through the center of the packing frames, and drives the packing frames to rotate around the rotating shaft.

The hollow structures of the packing frames are filled with packings; the packings are natural clinoptilolite, and the particle size of the natural clinoptilolite is 4 min; the mesh diameter of the disks is 0.85 mm; the mesh density of the disks is set at 20 meshes; and the packing density of the packings is 80%.

1. Natural clinoptilolite was added into the packed rotating biological contactor, the total volume of packings accounted for 30% the volume of the reaction pool; the packed rotating biological contactor was cultivated by means of continuous water inflow, the ammonia nitrogen concentration of the simulated inflow water was 50 mg/L, HRT was 8 h, the water temperature was controlled at 30° C., and the rotating speed of the packed rotating biological contactor was maintained at 4 r/min; the concentrations of ammonia nitrogen, nitrite nitrogen and nitrate nitrogen in the outflow water were detected periodically so as to control the adsorption-desorption processes of ammonia nitrogen.

2. According to the experimental results, during the adsorption stage, the ammonia nitrogen concentration in the outflow water decreased gradually; when the adsorption approached saturation, the ammonia nitrogen concentration in the outflow water increased gradually; when the ammonia nitrogen concentration in the outflow water increased to 45 mg/L, the inlet gate and the outlet gate were shut off, and the water in the reaction pool was inoculated with activated sludge (MLSS of the sludge was 3000 mg/L, and the ratio of the adding quantity of the sludge to the volume of the reaction pool was 10 g/L); an alkalinity adding device was used to supplement the alkalinity, in which NaHCO₃ was added at a mass ratio of sodium bicarbonate to the ammonia nitrogen in the water within the reaction pool of 7.5:1; the aerating device was activated to maintain the dissolved oxygen concentration in the water within the reaction pool at 5±0.5 mg/L, the rotating speed of the packed rotating biological contactor was maintained at 5 r/min, at which time the nitration reaction was ongoing. At this moment, the ammonia nitrogen concentration in the reaction pool decreased gradually, and the nitrate nitrogen concentration increased slowly; when the nitrate nitrogen concentration in the water within the reaction pool increased to 40 mg/L, the nitration reaction was finished; microorganisms gradually formed biofilms on the surface of the packings, NOB gradually dominated in the biofilms, and the acclimation of the packed rotating biological contactor was completed.

Eight packed rotating biological contactors that have been acclimated were divided into two groups (four in each group) and connected in series to two rotating shafts, which are driven by an electric motor and the rotating speed was maintained at 10±2 r/min; the ammonia nitrogen concentration of the inflow water to be treated was 120 mg/L, HRT was 12±2 h, and the water temperature was controlled at 30° C.; after treatment through the packed rotating biological contactor, more than 80% of ammonia nitrogen was converted into nitrate nitrogen, and the concentration of remaining ammonia nitrogen was 15-20 mg/L; the water in the reaction pool was pumped by a centrifugal pump for irrigation; so far, one cycle has been finished, then the water inflow was continued and the above operations were repeated.

It was demonstrated. from the experiment that, when the ammonia nitrogen concentration of the water to be treated was 120 mg/L, treatment through the packed rotating biological contactor can realize the entrapment and conversion of ammonia nitrogen, as well as recycling for irrigation.

The foregoing is only one preferable implementation of the present disclosure. It should be noted to persons with ordinary skills in the art that several improvements and modifications can be made without deviating from the principle of the present disclosure, which are also considered as the protection scope of the present disclosure.

What is claimed is:

1. A packed rotating biological contactor, wherein, comprising a rotating shaft, several pumping plates and several packing frames; each of the packing frames is formed by engaging two meshed disks; the packing frames have hollow structures; the hollow structures of the packing frames are filled with packings, and the packings comprise natural zeolite and/or medicinal stone;
the rotating shaft passes through the center of the packing frames, and drives the packing frames to rotate around the rotating shaft.

2. The packed rotating biological contactor according to claim 1, wherein, the mesh diameter of the disks is 0.85-2 mm; the mesh density of the disks is set at 10-20 meshes; the particle size of the packings is 3-18 mm; and the packing density of the packings is 60-80%.

3. The packed rotating biological contactor according to claim 1, wherein, the packing frames are made of wood, bamboo, PMMA, or PVC.

4. The packed rotating biological contactor according to claim 2, wherein, the packing frames are made of wood, bamboo. PMMA, or PVC.

5. A method for ammonia nitrogen conversion based on the packed rotating biological contactor, wherein, comprising the following steps:
(1) placing the packed rotating biological contactor into a reactor, simulating continuous inflow of water, the packings of the packed rotating biological contactor adsorbing the inflow water; when the ammonia nitrogen concentration in outflow water is reduced to 20-30% of the ammonia nitrogen concentration in the simulated inflow water, continuing the water inflow; when the ammonia nitrogen concentration in the outflow water is raised to 90-100% of the ammonia nitrogen concentration in the simulated inflow water, stopping the water inflow and the water outflow; inoculating the water within the reactor with activated sludge, and regulating alkalinity and aerating; the microorganism in the activated sludge is converted, when the nitrate nitrogen concentration in the water within the reactor is raised to 70-90% of the ammonia nitrogen concentration in the simulated inflow water, the conversion is completed; then draining the reactor;
(2) repeating (1) until the hydraulic retention time during the adsorption process is 10±2 h, to get a rotating biological contactor having the ability of ammonia nitrogen conversion;
(3) placing the rotating biological contactor having the ability of ammonia nitrogen conversion into a treatment reactor, and continuously inflowing the water to be treated for ammonia nitrogen conversion;
the packed rotating biological contactor is the packed rotating biological contactor according to claim 1;
the reagent for regulating alkalinity is NaHCO₃ or Na₂CO₃, and the mass ratio of the reagent for regulating alkalinity to the ammonia nitrogen in the water within the reactor is (7-9):1.

6. The method according to claim 5, wherein, the mesh diameter of the disks is 0.85-2 mm; the mesh density of the disks is set at 10-20 meshes; the particle size of the packings is 3-18 mm; and the packing density of the packings is 60-80%.

7. The method according to claim 5, wherein, the packing frames are made of wood, bamboo, PMMA, or PVC.

8. The method according to claim 6, wherein, the packing frames are made of wood, bamboo, PMMA, or PVC.

9. The method according to claim 5, wherein, in step (1), 50% of the area of the packed rotating biological contactor is immersed under the liquid level; and the total volume of the packings in the packed rotating biological contactor is 25-50% of the volume of the reactor;
the ammonia nitrogen concentration of the simulated inflow water is 50 mg/L, and its pH value is 7.0±0.5;
the adsorption comprises the following parameters: the rotating speed of the packed rotating biological contactor is 0.6-15 r/min, the water temperature is 30±5° C., and the hydraulic retention time is 8-16 h.

10. The method according to claim 6, wherein, in step (1), 50% of the area of the packed rotating biological contactor is immersed under the liquid level; and the total volume of the packings in the packed rotating biological contactor is 25-50% of the volume of the reactor;
the ammonia nitrogen concentration of the simulated inflow water is 50 mg/L, and its pH value is 7.0±0.5;
the adsorption comprises the following parameters: the rotating speed of the packed rotating biological contactor is 0.6-15 r/min, the water temperature is 30±5° C., and the hydraulic retention time is 8-16 h.

11. The method according to claim 7, wherein, in step (1), 50% of the area of the packed rotating biological contactor is immersed under the liquid level; and the total volume of the packings in the packed rotating biological contactor is 25-50% of the volume of the reactor;
the ammonia nitrogen concentration of the simulated inflow water is 50 mg/L, and its pH value is 7.0±0.5;
the adsorption comprises the following parameters: the rotating speed of the packed rotating biological contactor is 0.6-15 r/min, the water temperature is 30±5° C., and the hydraulic retention time is 8-16 h.

12. The method according to claim 8, wherein, in step (1), 50% of the area of the packed rotating biological contactor is immersed under the liquid level; and the total volume of the packings in the packed rotating biological contactor is 25-50% of the volume of the reactor;
the ammonia nitrogen concentration of the simulated inflow water is 50 mg/L, and its pH value is 7.0±0.5;
the adsorption comprises the following parameters: the rotating speed of the packed rotating biological contactor is 0.6-15 r/min, the water temperature is 30±5° C., and the hydraulic retention time is 8-16 h.

13. The method according to claim 5. wherein, in step (1), the MLSS of the activated sludge is 2500-3000 mg/L; and the ratio of the adding mass of the activated sludge to the volume of the reactor is (10-15) g:1 L;
the aeration maintains the dissolved oxygen concentration of the water within the reactor at 3-5 mg/L.

14. The method according to claim 6, wherein, in step (1), the MISS of the activated sludge is 2500-3000 mg/L; and the ratio of the adding mass of the activated sludge to the volume of the reactor is (10-15) g:1 L;
the aeration maintains the dissolved oxygen concentration of the water within the reactor at 3-5 mg/L.

15. The method according to claim 5, wherein, in step (3), the ammonia nitrogen concentration of the water to be treated is 20-150 mg/L.

16. The method according to claim 5, wherein, in step (3), the parameters for ammonia nitrogen conversion comprise: 50% of the area of the packed rotating biological contactor is immersed under the liquid level; the rotating speed of the packed rotating biological contactoris 0.6-8 r/min, and the water temperature is 30±5° C.

17. The method according to claim 15, wherein, in step (3), the parameters for ammonia nitrogen conversion comprise: 50% of the area of the packed. rotating biological contactor is immersed under the liquid level; the rotating speed of the packed rotating biological contactor is 0.6-8 r/min, and the water temperature is 30±5° C.,

18. The method according to claim 5, wherein, in step (3), during the process of ammonia nitrogen conversion, when the ammonia nitrogen concentration in the outflow water is below 10 mg/L, it is in normal operation; when the ammonia nitrogen concentration in the water within the treatment reactor is increased to 20±5 mg/L, it is the operational control point; when the operational control point is achieved, post-treatment is conducted, which comprises the following steps: stopping the water inflow, supplementing the alkalinity and aerating for ammonia nitrogen desorption-conversion, until the ammonia. nitrogen concentration in the water within the treatment reactor is reduced to below 10 mg/L, draining the treatment reactor and then continuously inflowing the water to be treated for ammonia nitrogen conversion.

19. The method according to claim 15, wherein, in step (3), during the process of ammonia nitrogen conversion, when the ammonia nitrogen concentration in the outflow water is below 10 mg/L, it is in normal operation; when the ammonia nitrogen concentration in the water within the treatment reactor is increased to 20±5 mg/L, it is the operational control point; when the operational control point is achieved, post-treatment is conducted, which comprises the following steps: stopping the water inflow, supplementing the alkalinity and aerating for ammonia nitrogen desorption-conversion, until the ammonia nitrogen concentration in the water within the treatment reactor is reduced to below 10 mg/L, draining the treatment reactor and then continuously inflowing the water to be treated for ammonia nitrogen conversion.

20. The method according to claim 5, wherein, in step (3), when the packings in the packed rotating biological contactor harden or the biofilm is too thick, the method further comprises rinsing the packings.
